(19) United States
(12) Patent Application Publication
(10) Pub. No.: US 2022/0376272 A1
(43) Pub. Date: Nov. 24, 2022

(54) PROTON EXCHANGE MEMBRANES AND METHODS OF PREPARING SAME

(71) Applicant: NABORS ENERGY TRANSITION SOLUTIONS LLC, Houston, TX (US)

(72) Inventors: Evan JOHNSON, Spring, TX (US); Eli ADLER, Olympia, WA (US); Dylan COOK, Spring, TX (US); Aaron ADLER, Olympia, WA (US); Paul YOLLIN, Spring, TX (US)

(21) Appl. No.: 17/664,069

(22) Filed: May 19, 2022

Related U.S. Application Data
(60) Provisional application No. 63/191,287, filed on May 20, 2021.
(60) Provisional application No. 63/219,552, filed on Jul. 8, 2021.

(51) Int. Cl. H01M 8/0245; H01M 8/0234; H01M 8/0239; B33Y 70/00; B33Y 80/00

(52) U.S. Cl. CPC H01M 8/0245; H01M 8/0234; H01M 8/0239; B33Y 70/00; B33Y 80/00; B29C 64/118

(57) ABSTRACT

Method of preparing a proton exchange membrane (PEM) include mixing a precursor of a perfluorosulfonic acid polymer with a second material to form a precursor material in a reduced humidity zone; extruding the precursor material under reduced humidity to form a filament; 3D printing the PEM with the filament; converting the precursor of the perfluorosulfonic acid polymer to the perfluorosulfonic acid polymer within the PEM; and coating the PEM.

### CROSS-REFERENCE TO RELATED APPLICATION(S)

This Application claims priority under 35 U.S.C. § 119(e) to U.S. Provisional Patent Application No. 63/191,287, entitled “SYSTEMS AND METHODS FOR A PROTON EXCHANGE MEMBRANE,” by Evan Johnson et al., filed May 20, 2021, and claims priority under 35 U.S.C. § 119(e) to U.S. Provisional Patent Application No. 63/219,552, entitled “SYSTEMS AND METHODS FOR A PROTON EXCHANGE MEMBRANE,” by Evan Johnson et al., filed Jul. 8, 2021, both of which are assigned to the current assignee hereof and incorporated by reference herein in their entireties.

### FIELD OF THE DISCLOSURE

The technical disclosure herein relates to proton exchange membranes, and methods of making and using the same.

### BACKGROUND

As environmental considerations become more significant, fuel cells have become increasingly popular, as they provide a promising sustainable approach to address the ongoing energy crisis and associated environmental concerns. Fuel cells are used as sources of power for a wide range of applications that require clean, quiet, and efficient portable power.

Fuel cells convert the chemical potential energy of a fuel into electrical energy via an electrochemical reaction. A fuel cell may include a cathode and an anode, and a proton exchange membrane (“PEM”) disposed between the cathode and the anode. A PEM serves as a separator, preventing mixing of the fuel (i.e., hydrogen or methanol) and the oxidant (i.e., pure oxygen or air). In addition, the PEM acts as a solid electrolyte for transporting protons from the anode to the cathode.

For best results in these types of fuel cells, PEMs must have certain characteristics, including high proton conductivity, high electronic resistivity, durability, low reactant permeation, and stability. For example, PEMs have a tendency to tear, especially when being handled or where compression is applied. Another issue is that PEMs have a tendency to be permeable to gases and water. This permeability is undesirable, as it may result in unoxidized fuel entering the PEM, and then escaping from the fuel cell through the peripheral edges of the PEM or permitting undesired direct mixing of the fuel and oxidant, thereby resulting in fuel and/or oxidant loss, water leaking from the PEM, thereby degrading the PEM itself or PEM performance, or any combination of the foregoing problems.

The cost of PEMs can also be an issue. Most PEM materials are based on perfluorinated polymers such as Nafion™ and various sulfonated derivatives of non-fluorinated aromatic high-performance polymers. Nafion™, however, is expensive. Moreover, to speed up the reactions in the fuel cell, a platinum catalyst is typically applied to both sides of the PEM. On the anode side, the platinum catalyst enables hydrogen molecules to be split into protons and electrons. On the cathode side, the platinum catalyst enables oxygen reduction by reacting with the protons generated by the anode, producing water. In some cases, the cathode and/or the anode are formed from a platinum catalyst.

A variety of PEMs are known and used in the art, but are generally high cost and/or suffer from other disadvantages. Therefore, there is a need for a more economical PEM, which also minimizes the presence of, or is free from, these disadvantages.

### BRIEF DESCRIPTION OF THE DRAWINGS

The present disclosure is best understood from the following detailed description when read with the accompanying figures. It is emphasized that, in accordance with the standard practice in the industry, various features are not drawn to scale. In fact, the dimensions of the various features may be arbitrarily increased or reduced for clarity of discussion.

FIG. 1 is a schematic diagram of a proton exchange membrane-based fuel cell according to one or more aspects of the present disclosure.

FIG. 2 is a flow chart of a method according to one or more aspects of the present disclosure.

FIG. 3 is a flow chart of another method according to one or more aspects of the present disclosure.

### DETAILED DESCRIPTION

It is to be understood that the following disclosure provides many different embodiments, or examples, for implementing different features of various embodiments. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed. Moreover, the formation of a first feature over or on a second feature in the description that follows may include embodiments in which the first and second features are formed in direct contact, and may also include embodiments in which additional features may be formed interposing the first and second features, such that the first and second features may not be in direct contact.

The present disclosure describes methods for providing improved PEMs. In particular, the PEMs have increased water uptake and water tolerance, increased proton permeability, and/or increased durability. In various embodiments, cost of the PEMs is also lowered through the alternative selection of materials as described herein, and/or via the use of 3D printing to manufacture the PEMS from filaments of the feedstock material instead of through conventional Nafion™ filter formation methods. Improved membrane characteristics can be achieved by addition of different materials, such as water or solvent soluble materials, reinforcement materials, or both.

In various embodiments, production of the PEM begins preferably with a precursor of a perfluorosulfonic acid polymer (such as a precursor of Nafion™) that is mixed with different materials to make a filament for an additive manufacturing process. While other suitable precursors or materials may be used (e.g., sulfonated poly (ether ether ketone) (sPEEK), a perfluoroalkoxy alkane (PFA), sulfonated polyimide, or polyethersulfone), in any suitable form, preferably pellets of the precursor tend to have suitable melt properties. In certain embodiments, the layers in the additive manufacturing process are reinforced with different materials, such as graphene, fiberglass, polyvinylidene fluoride (PVDF), and/or carbon fibers. The final product, in some embodiments, is coated with graphene on one or both sides of the membrane. The use of platinum or iridium for the anode or cathode can be minimized or avoided by coating the membrane with less costly conductive materials, such as graphene. Thus, the PEMs according to this disclosure are preferably coated with one or more layers of a conductive material that is substantially free (e.g., a detectable amount but one that is less than about 5%, preferably less than about 4%, and more preferably less than about 3%, each by weight), essentially free (e.g., a detectable amount but one that is less than about 2%, preferably less than about 1%, and more preferably less than 0.5%, each by weight), or entirely free, of platinum. The conductive material is preferably non-metallic to minimize cost, weight, and otherwise optimize desirable properties of the coated PEM.

Fused filament additive manufacturing, such as three-dimensional (3D) printing, is a manufacturing technique in which materials such as plastic or metal are deposited in layers to produce a 3D structure, often with complex shapes and features. Advantageously, 3D printing PEMs provides both a means of manufacture and a way to make new types of membranes that are not readily producible with current PEM manufacturing technology. In some embodiments, 3D printing PEMs allows the adjustment of an array of characteristics of the membrane, such as thickness, shape, composition, and surface texture. In certain embodiments, 3D printing helps facilitate the rapid production of varying structures and materials to screen for new ways to improve upon traditional PEMs, such as by changing polymer orientation or layering different materials to combine favorable characteristics. In addition, 3D printing enables the reinforcement of the membrane with graphene, glass fibers, carbon fibers, PVDF, or other materials, or any combination thereof. In still other embodiments, 3D printing enables addition of a plasticizer to make sPEEK into a 3D printer filament.

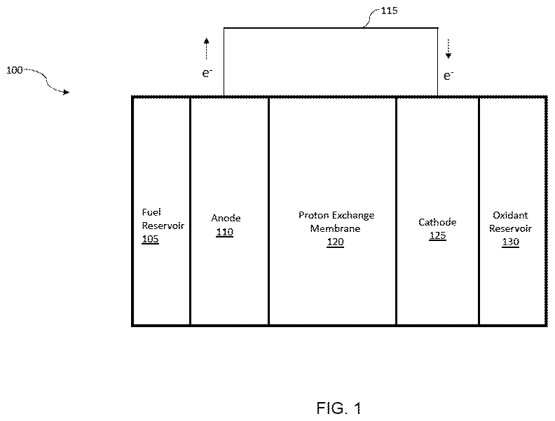

FIG. 1 is a block diagram of a PEM-based fuel cell 100. The PEM-based fuel cell 100 shown in FIG. 1 includes a fuel reservoir 105, an oxidant reservoir 130, a PEM 120, and an anode 110 interconnected through an electrical interconnection 115 to a cathode 125. Anode 110 is typically made of a catalyst material, such as platinum, but may be made from any suitable conductive material. Oxidation of the fuel at the anode 110 produces electrons that flow through the interconnection 115 to the cathode 125, thereby producing an electric current between the anode and cathode. The electrons react with an oxidant at the cathode 125. Cathode 125 is also typically made of a catalyst material, such as platinum, but may be made from any suitable conductive material.

In various embodiments, the fuel for the fuel cell 100 is hydrogen. At the anode 110, the hydrogen molecule in gas form is preferably split in situ into hydrogen ions (protons) and electrons when needed for operation of the fuel cell 100. The hydrogen ions pass through the PEM 120 to the cathode 125, while the electrons flow through the electrical interconnection 115 and produce electric power. PEM 120 is a hydrated membrane that allows passage of protons from the fuel reservoir 105 to the oxidant reservoir 130, but does not allow other ions, oxidants, or gases to pass. In an ideal case, PEM 120 is impermeable to everything except protons. The half-cell chemical equation at the anode is 2 H₂→4H++4e⁻.

Oxygen, usually in the form of air, is supplied to the cathode 125, and the oxygen combines with the electrons and the hydrogen ions to produce water. The half-cell chemical reaction at the cathode is O₂+4H⁺+4e⁻→2 H₂O. The overall cell reaction is 2 H₂+O₂→2 H₂O+heat+electrical energy.

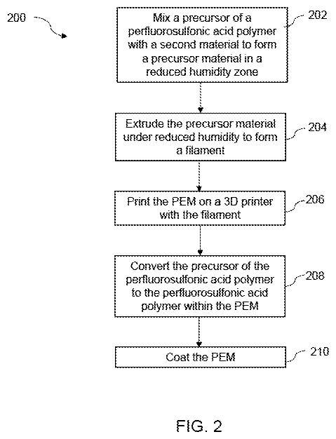

Referring now to FIG. 2, an embodiment of a method 200 of making a PEM according to one or more aspects of the present disclosure is described. In various embodiments, method 200 is carried out in large batches or in a continuous process, and many of the steps are automated.

At step 202, a precursor of a perfluorosulfonic acid polymer (e.g., Nafion™) is mixed with a second material to form a precursor material in a reduced humidity zone. In various embodiments, Nafion™ precursor pellets (e.g., Nafion™ R-1100 Precursor Beads) and other materials suitable for making a PEM are mixed together. A Nafion™ precursor is generally used because it is more melt processable and is easier to extrude than Nafion™ itself. In some embodiments, a Nafion™ substitute such as sPEEK, a PFA, sulfonated polyimide, or polyethersulfone, is used instead of a precursor of a perfluorosulfonic acid polymer. In this case, sPEEK, a PFA, sulfonated polyimide, or polyethersulfone is mixed with a second material to form a precursor material.

By “reduced humidity” is meant a relative humidity (RH) of less than about 30%, such as less than about 20%, 10%, 5%, or 1%. In an exemplary embodiment, the RH is less than 1%. The precursor of the perfluorosulfonic acid polymer and/or other precursor material(s) can be sensitive to moisture, and it may be useful to dehumidify the room or container where it is stored, melted, and processed. In some embodiments, the perfluorosulfonic acid polymer and/or the precursor material is baked and kept in a controlled zone with 0% RH.

In some embodiments, the second material includes a PFA, which can improve material costs and give better membrane characteristics. In other embodiments, the second material includes a water or solvent soluble material such as polyvinyl alcohol (PVA) or poly (ether ether ketone (PEEK). In various embodiments, the second material includes a PFA, PVA, PEEK, polybenzimidazole, sulfonated polyimide, polyethersulfone, or any combination thereof. The water-soluble material is able to dissolve when placed in contact with water, leaving behind a nanoporous membrane that gases will be unable to permeate. This can increase water uptake and improve proton permeability through the membrane, both characteristics of which will reduce the need to minimize the membrane thickness while improving performance. In several embodiments, the second material is added to the precursor of the perfluorosulfonic acid polymer such that the resulting precursor material includes about 1 to 20% by weight, preferably about 5 to 15% by weight, and more preferably about 8-11% by weight of the second material combined with the first. In other preferred embodiments, the resulting precursor material includes about 0.1% to 10% by weight of the second material, preferably about 0.5 to 5% by weight of the second material (e.g., 45%, 3%, 2%, or 1%).

In certain embodiments, addition of a reinforcement material, such as fiberglass, PVDF, carbon fibers, graphene oxide, or graphene, to the mixture improves membrane permeability and membrane durability. Graphene, for example, improves proton permeability.

At step 204, the precursor material is extruded under reduced humidity to form a filament. In some embodiments, the precursor material is extruded at temperatures between about 270° C. to about 300° C. In certain embodiments, combined materials vary in temperature according to the specific mixture, and the precursor material can have a large range of extrusion temperatures, such as about 250° C. to about 450° C. In various embodiments, a filament extruder is preheated and an extruder hopper is loaded with precursor pellets. As described above, the precursor pellets can include pellets including the precursor of a perfluorosulfonic acid polymer and the second material, and in some embodiments, reinforcement materials can be included with the second material or provided separately to the extrusion line. In some embodiments, a cover is placed on the extruder hopper to avoid contamination and minimize moisture.

If reinforcement materials are added, it may be necessary to pelletize the filament and re-extrude the filament to ensure the fibers are consistently mixed throughout the filament. For example, the precursor of the perfluorosulfonic acid polymer, the second material, and the reinforcement material may be mixed to form the precursor material in a reduced humidity environment. This precursor material may then be extruded under reduced humidity to form a filament. Next, the filament may be chopped into pellets that include the precursor of the perfluorosulfonic acid polymer, the second material, and the reinforcement material. These pellets may then be re-extruded to form a second filament.

The first one to two feet of filament are typically disposed of because it will likely have impurities and will not have a consistent diameter because of air pockets. The rest of the filament is generally kept and wound into rolls. The speed of the filament motor and the cooling fan speed may be adjusted until the filament has a consistent diameter that is about 1.5 to 2 mm, preferably about 1.6 to 1.9 mm, and in one embodiment is close to 1.75 mm. The filament is then kept in rolls in a vacuum sealed container. One or more stepper motors may be used to advance the extruded filament so it can sufficiently cool before being wound into a roll of filament for use in making PEMs.

At step 206, the PEM is printed on a 3D printer with the filament. An enclosed 3D printer is generally preheated to combat moisture absorbing into the filament and to keep the ambient temperature constant. In an exemplary embodiment, a borosilicate glass printer bed is used to deal with the high temperatures, while evenly distributing heat. Importantly, the glass printer bed serves as a very flat surface so that the PEM can be more easily printed with a very precise and consistent thickness.

In certain embodiments, the filament is loaded into the 3D printer, and the printhead extruder is primed. The filament is either printed directly onto the bed in a sheet, or onto a substrate layer of soluble filament that can be dissolved to prevent damage to the printed membrane during removal of the substrate layer.

In various embodiments, the 3D printer is a multifilament 3D printer. Advantageously, a multifilament 3D printer allows different, materials to be printed in layers to improve proton permeability in the desired direction across the membrane. In certain embodiments, additional filaments of other materials are also loaded into the 3D printer. The other materials include water/solvent soluble materials (e.g., PVA or PEEK), a perfluorosulfonic acid polymer (e.g., Nafion™), reinforcement materials or fibers, sPEEK, PVDF, or a combination or reaction product of any of the foregoing. A woven mesh of fibers may also be added in between layers to increase the durability of the PEM, and the various types of reinforcing materials described above for inclusion in the filaments can instead, or additively, be distributed amongst such a woven mesh of fibers, or disposed over a layer of printed PEM, to provide various properties including compression and tear strength, conductivity, etc. The same or different reinforcing material(s) can be used in this manner relative to the reinforcing material(s) formed within the filament as described herein. In various embodiments, 3D printing includes 3D printing with one or more additional filaments in an arrangement in between layers of the filament, in between fibers of the filament to form a layer, interwoven with the filament, or interknit with the filament.

At step 208, the precursor of the perfluorosulfonic acid polymer is converted to the perfluorosulfonic acid polymer within the PEM. Typically, the printed PEM is first removed from the print bed, and if necessary, any soluble support layer that is attached to the PEM is dissolved with the proper solvent. In some embodiments, the PEM is heat pressed or hot rolled to improve layer adhesion and to further reduce thickness to increase the operating efficiency of the fuel cell in which the PEM will be used.

After the precursor polymer is formed into its desired geometry (i.e., the PEM) during 3D printing, the precursor polymer must still be “activated” via a hydrolysis process that converts the sulfonyl end groups to sulfonic acid or salt. This conversion is facilitated via sulfonation in a chemical bath. The components of the chemical bath include dimethyl sulfoxide (DMSO), potassium hydroxide (KOH), and water. In an exemplary embodiment, the chemical bath is at a temperature of about 60° C. to 90° C., preferably about 70° C. to 80° C., with a temperature of about 75° C. being ideal, and includes about 25 to 45 weight percent, preferably about 30-40 weight percent DMSO, about 10 to 20 weight percent, preferably about 13-17 weight percent KOH, and the remainder being water. According to still other embodiments, adding distinct sulfonations of sPEEK can be beneficial, such as, adding between 50-75 weight percent DS. Since the membranes are typically thin they may only need to soak for about ten to fifteen minutes to fully convert, or activate, in the chemical bath. The membranes may generally be about 0.052 mm to about 0.2 mm thick, for example about 0.18 mm. The thicknesses of the printed PEMs can be chosen for specific applications, but the practical minimum thickness is typically about 0.04 mm, and there are typically no maximum thickness limitations. The membranes are then washed in deionized water, dried, and stored, preferably in a vacuum sealed container until further processed or used in a fuel cell such as fuel cell 100.

At step 210, the PEM is coated. Two particularly suitable methods for coating the printed PEMs are spin coating and spray coating. Spin coating involves placing the post-processed membrane onto a spinning platform, and dripping a coating such as graphene mixed with a binder onto the PEM to deposit a thin and substantially uniform thickness coat of material to improve one or more characteristics of the PEM, such as conductivity. Spray coating can be done on a 3D printer by incorporating an atomizing spray nozzle onto a printhead, and utilizing the movement of the x, y, and z axis to spray a coat onto the PEM. Thickness, number of layers, and coating temperature can all be controlled by the tools already built into the 3D printer. In various embodiments, the coating is at least about 0.02 mm thick.

In an exemplary embodiment, the PEM forms a substrate and the coating includes disposing a layer of graphene over the PEM substrate. In various embodiments, the PEM is coated on both sides with graphene at the same time, or in sequence. In some embodiments, the graphene is doped or bonded to other materials, such as sulfur, which can modify properties such as conductivity as desired.

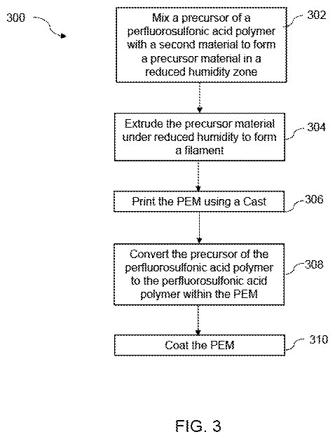

Referring now to FIG. 3, another embodiment of a method 300 of making a PEM according to one or more aspects of the present disclosure is described. In various embodiments, method 200 is carried out in large batches or in a continuous process, and many of the steps are automated.

At step 302, a precursor of a perfluorosulfonic acid polymer (e.g., Nafion™) is mixed with a second material to form a precursor material in a reduced humidity zone. In various embodiments, Nafion™ precursor pellets (e.g., Nafion™ R-1100 Precursor Beads) and other materials suitable for making a PEM are mixed together. A Nafion™ precursor is generally used because it is more melt processable and is easier to extrude than Nafion™ itself. In some embodiments, a Nafion™ substitute such as sPEEK, a PFA, sulfonated polyimide, or polyethersulfone, is used instead of a precursor of a perfluorosulfonic acid polymer. In this case, sPEEK, a PFA, sulfonated polyimide, or polyethersulfone is mixed with a second material to form a precursor material.

By “reduced humidity” is meant a relative humidity (RH) of less than about 30%, such as less than about 20%, 10%, 5%, or 1%. In an exemplary embodiment, the RH is less than 1%. The precursor of the perfluorosulfonic acid polymer and/or other precursor material(s) can be sensitive to moisture, and it may be useful to dehumidify the room or container where it is stored, melted, and processed. In some embodiments, the perfluorosulfonic acid polymer and/or the precursor material is baked and kept in a controlled zone with 0% RH.

At step 304, the mixture is cast through known casting procedures, such that a film is cast at a thickness between 1 micron and 300 microns. According to certain embodiments, the film may act as a PEM directly following the cast processes.

According to still other embodiments, the film may require additional processing to act as a PEM. For example, at step 306, the precursor of the perfluorosulfonic acid polymer is converted to the perfluorosulfonic acid polymer within the film top form the PEM. Typically, the printed PEM is first removed from the cast form, and if necessary, any soluble support layer that is attached to the PEM is dissolved with the proper solvent. In some embodiments, the PEM is heat pressed or hot rolled to improve layer adhesion and to further reduce thickness to increase the operating efficiency of the fuel cell in which the PEM will be used.

After the precursor polymer is formed into its desired geometry (i.e., the PEM) during casting, the precursor polymer may still need to be “activated” via a hydrolysis process that converts the sulfonyl end groups to sulfonic acid or salt. This conversion is facilitated via sulfonation in a chemical bath. The components of the chemical bath include dimethyl sulfoxide (DMSO), potassium hydroxide (KOH), and water. In an exemplary embodiment, the chemical bath is at a temperature of about 60° C. to 90° C., preferably about 70° C. to 80° C., with a temperature of about 75° C. being ideal, and includes about 25 to 45 weight percent, preferably about 30-40 weight percent DMSO, about 10 to 20 weight percent, preferably about 13-17 weight percent KOH, and the remainder being water. Since the membranes are typically thin they may only need to soak for about ten to fifteen minutes to fully convert, or activate, in the chemical bath. The membranes may generally be about 0.052 mm to about 0.2 mm thick, for example about 0.18 mm. The thicknesses of the printed PEMs can be chosen for specific applications, but the practical minimum thickness is typically about 0.04 mm, and there are typically no maximum thickness limitations. The membranes are then washed in deionized water, dried, and stored, preferably in a vacuum sealed container until further processed or used in a fuel cell such as fuel cell 100.

At step 308, the PEM may optionally be coated. Three particularly suitable methods for coating the cast PEMs are spin coating, blade coating, or spray coating.

In an exemplary embodiment, the PEM forms a substrate and the coating includes disposing a layer of graphene over the PEM substrate. In various embodiments, the PEM is coated on both sides with graphene at the same time, or in sequence. In some embodiments, the graphene is doped or bonded to other materials, such as sulfur, which can modify properties such as conductivity as desired.

Once the PEM is produced by embodiments described herein, it may be installed into a fuel cell, such as fuel cell 100 in FIG. 1. As shown, fuel cell 100 includes an anode 110 and a first fluid (fuel in fuel reservoir 105), a cathode 125 and a second fluid (oxidant in oxidant reservoir 130) and a PEM 120 prepared according to the disclosure herein and disposed between the anode 110 and the cathode 125 to inhibit or prevent mixing of the first and second fluids.

To provide an overview of various aspects of the present disclosure, various embodiments are set forth below. In a first aspect, the present disclosure encompasses a method of preparing a proton exchange membrane (PEM) that includes: mixing a precursor of a perfluorosulfonic acid polymer with a second material to form a precursor material in a reduced humidity zone; extruding the precursor material under reduced humidity to form a filament; 3D printing the PEM with the filament; converting the precursor of the perfluorosulfonic acid polymer to the perfluorosulfonic acid polymer within the PEM; and coating the PEM with a conductive material that is at least essentially free of platinum. In one embodiment, the second material includes a perfluoroalkoxy alkane (PFA), polybenzimidazole, polyethersulfone, sulfonated polyimide, a water-soluble material, or a combination thereof. In another embodiment, the water-soluble material includes polyvinyl alcohol (PVA), poly (ether ether ketone (PEEK), or a combination thereof.

In a preferred embodiment, mixing the precursor of the perfluorosulfonic acid polymer with the second material includes mixing the precursor of the perfluorosulfonic acid polymer with the second material and a reinforcement material. In another embodiment, the reinforcement material includes fiberglass, poliyvinylidene fluoride (PVDF), carbon fibers, graphene, graphene oxide, or any combination thereof.

In another embodiment, the 3D printing includes using a multi-filament printer. In a preferred embodiment, the 3D printing includes 3D printing with an additional filament in an arrangement: in between layers of the filament, in between fibers of the filament to form a layer, interwoven with the filament, or interknit with the filament. In yet another preferred embodiment, the additional filament includes a water or solvent soluble material, a reinforcement fiber, sulfonated poly(ether ether ketone) (sPEEK), polyvinylidene fluoride (PVDF), a perfluorosulfonic acid polymer, or a combination or a reaction product thereof. In a further preferred embodiment, the additional filament includes the reinforcement fiber, and the reinforcement fiber includes fiberglass, PVDF, or carbon fibers.

In a further embodiment of the disclosure, the methods described above further include at least one of: heat pressing the PEM; hot rolling the PEM; washing the PEM in deionized water; or drying the PEM. In another embodiment, the PEM forms a substrate and the coating includes disposing a layer of graphene over the PEM substrate. In one preferred embodiment, the PEM is coated on both sides and the graphene is doped with another element. In another embodiment, the coating includes spin coating or spray coating. In a preferred embodiment, the coating includes spray coating, and the PEM forms a substrate that is spray coated by a 3D printer.

In another aspect of the disclosure, the invention encompasses a proton exchange membrane prepared by the methods described herein. In yet a further aspect of the disclosure, the invention encompasses a fuel cell including: an anode and a first fluid; a cathode and a second fluid; and the proton exchange membrane disclosed herein disposed therebetween to inhibit mixing of the first and second fluids.

In yet another aspect of the disclosure, the invention encompasses a method of preparing a proton exchange membrane (PEM), including: mixing pellets of a precursor of a perfluorosulfonic acid polymer, a second material, and a reinforcement material to form a precursor material in a reduced humidity environment; extruding the precursor material under reduced humidity conditions to form a filament; chopping the filament into pellets including the precursor, the second material, and the reinforcement material; extruding the pellets including the precursor, the second material, and the reinforcement material into a second filament; 3D printing the PEM with the second filament; converting the precursor of the perfluorosulfonic acid polymer to the perfluorosulfonic acid polymer within the PEM; and coating the PEM with a layer of graphene.

In one embodiment, the second material includes a perfluoroalkoxy alkane (PFA), a water-soluble material, or a combination thereof, and the reinforcement material includes fiberglass, polyvinylidene fluoride (PVDF), carbon fibers, graphene, or a combination thereof. In another embodiment, the 3D printing includes 3D printing with an additional filament in an arrangement: in between layers of the second filament, in between fibers of the second filament to form a layer, interwoven with the second filament, or interknit with the second filament. In a further embodiment, the additional filament includes a water or solvent soluble material, a reinforcement fiber, sulfonated poly(ether ether ketone) (sPEEK), polyvinylidene fluoride (PVDF), a perfluorosulfonic acid polymer, or a combination or reaction product thereof.

In another aspect of the present disclosure, the invention encompasses a method of preparing a proton exchange membrane (PEM), including: mixing a first material with a second material to form a precursor material, wherein the first material includes sulfonated poly (ether ether ketone) (sPEEK), a perfluoroalkoxy alkane (PFA), sulfonated polyimide, or polyethersulfone, and the second material is different from the first material; extruding the precursor material to form a filament; 3D printing the PEM with the filament; and coating the printed PEM with a conductive material that is at least essentially free of platinum. In one embodiment, the second material is selected to include polyvinyl alcohol (PVA), poly (ether ether ketone) (PEEK), polyvinylidene fluoride (PVDF), or a combination thereof. In one embodiment, mixing the first material with the second material includes mixing the first material with the second material and a reinforcement material. In another embodiment, the reinforcement material includes fiberglass, carbon fibers, graphene, graphene oxide, or any combination thereof.

In yet another aspect of the disclosure, the invention encompasses a method of preparing a proton exchange membrane (PEM), including: mixing pellets of a precursor of a perfluorosulfonic acid polymer, a second material, and a reinforcement material to form a precursor material in a reduced humidity environment; casting the material into a PEM of precursor PEM film; optionally converting the precursor of the perfluorosulfonic acid polymer to the perfluorosulfonic acid polymer within the PEM; and coating the PEM with a layer of graphene.

Thus, various systems, apparatuses, methods, etc. have been described herein. Although embodiments have been described with reference to specific example embodiments, it will be evident that various modifications and changes may be made to these embodiments without departing from the broader spirit and scope of the system, apparatus, method, and any other embodiments described and/or claimed herein. Further, elements of different embodiments in the present disclosure may be combined in various different manners to disclose additional embodiments still within the scope of the present embodiments. Additionally, the specification and drawings are to be regarded in an illustrative rather than a restrictive sense.

Many different aspects and embodiments are possible. Some of those aspects and embodiments are described herein. After reading this specification, skilled artisans will appreciate that those aspects and embodiments are only illustrative and do not limit the scope of the present invention. Embodiments may be in accordance with any one or more of the embodiments as listed below.

Embodiment 1. A method of preparing a proton exchange membrane (PEM), comprising: mixing a precursor of a perfluorosulfonic acid polymer with a second material to form a precursor material in a reduced humidity zone; extruding the precursor material under reduced humidity to form a filament; 3D printing the PEM with the filament; converting the precursor of the perfluorosulfonic acid polymer to the perfluorosulfonic acid polymer within the PEM; and coating the PEM with a conductive material that is at least essentially free of platinum.

Embodiment 2. The method of embodiment 1, wherein the second material comprises a perfluoroalkoxy alkane (PFA), polybenzimidazole, polyethersulfone, sulfonated polyimide, a water-soluble material, or a combination thereof.

Embodiment 3. The method of embodiment 2, wherein the water-soluble material comprises polyvinyl alcohol (PVA), poly (ether ether ketone) (PEEK), or a combination thereof.

Embodiment 4. The method of embodiment 2, wherein mixing the precursor of the perfluorosulfonic acid polymer with the second material comprises mixing the precursor of the perfluorosulfonic acid polymer with the second material and a reinforcement material.

Embodiment 5. The method of embodiment 4, wherein the reinforcement material comprises fiberglass, polyvinyldiene fluoride (PVDF), carbon fibers, graphene, graphene oxide, or any combination thereof.

Embodiment 6. The method of embodiment 1, wherein the 3D printing comprises using a multi-filament printer.

Embodiment 7. The method of embodiment 6, wherein the 3D printing comprises 3D printing with an additional filament in an arrangement: in between layers of the filament, in between fibers of the filament to form a layer, interwoven with the filament, or interknit with the filament.

Embodiment 8. The method of embodiment 7, wherein the additional filament comprises a water or solvent soluble material, a reinforcement fiber, sulfonated poly(ether ether ketone) (sPEEK), polyvinylidene fluoride (PVDF), a perfluorosulfonic acid polymer, or a combination or a reaction product thereof.

Embodiment 9. The method of embodiment 8, wherein the additional filament comprises the reinforcement fiber, and the reinforcement fiber comprises fiberglass, PVDF, or carbon fibers.

Embodiment 10. The method of embodiment 1, further comprising at least one of: heat pressing the PEM; hot rolling the PEM; washing the PEM in deionized water; or drying the PEM.

Embodiment 11. The method of embodiment 1, wherein the PEM forms a substrate and the coating comprises disposing a layer of graphene over the PEM substrate.

Embodiment 12. The method of embodiment 11, wherein the PEM is coated on both sides and the graphene is doped with another element.

Embodiment 13. The method of embodiment 1, wherein the coating comprises spin coating or spray coating.

Embodiment 14. The method of embodiment 13, wherein the coating comprises spray coating, and the PEM forms a substrate that is spray coated by a 3D printer.

Embodiment 15. A proton exchange membrane prepared by the method of embodiment 1.

Embodiment 16. A fuel cell comprising: an anode and a first fluid; a cathode and a second fluid; and the proton exchange membrane of embodiment 13 disposed therebetween to inhibit mixing of the first and second fluids.

Embodiment 17. A method of preparing a proton exchange membrane (PEM), comprising: mixing pellets of a precursor of a perfluorosulfonic acid polymer, a second material, and a reinforcement material to form a precursor material in a reduced humidity environment; extruding the precursor material under reduced humidity conditions to form a filament; chopping the filament into pellets comprising the precursor, the second material, and the reinforcement material; extruding the pellets comprising the precursor, the second material, and the reinforcement material into a second filament; 3D printing the PEM with the second filament; converting the precursor of the perfluorosulfonic acid polymer to the perfluorosulfonic acid polymer within the PEM; and coating the PEM with a layer of graphene.

Embodiment 18. The method of embodiment 17, wherein the second material comprises a perfluoroalkoxy alkane (PFA), a water-soluble material, or a combination thereof, and the reinforcement material comprises fiberglass, polyvinylidene fluoride (PVDF), carbon fibers, graphene, or a combination thereof.

Embodiment 19. The method of embodiment 17, wherein the 3D printing comprises 3D printing with an additional filament in an arrangement: in between layers of the second filament, in between fibers of the second filament to form a layer, interwoven with the second filament, or interknit with the second filament.

Embodiment 20. The method of embodiment 19, wherein the additional filament comprises a water or solvent soluble material, a reinforcement fiber, sulfonated poly(ether ether ketone) (sPEEK), polyvinylidene fluoride (PVDF), a perfluorosulfonic acid polymer, or a combination or reaction product thereof.

Embodiment 21. A proton exchange membrane (PEM) prepared by the method of embodiment 17.

Embodiment 22. A method of preparing a proton exchange membrane (PEM), comprising: mixing a first material with a second material to form a precursor material, wherein the first material comprises sulfonated poly (ether ether ketone) (sPEEK), a perfluoroalkoxy alkane (PFA), sulfonated polyimide, or polyethersulfone, and the second material is different from the first material; extruding the precursor material to form a filament; 3D printing the PEM with the filament; and coating the printed PEM with a conductive material that is at least essentially free of platinum.

Embodiment 23. The method of embodiment 22, wherein mixing the first material with the second material comprises mixing the first material with the second material and a reinforcement material.

Embodiment 24. The method of embodiment 23, wherein the reinforcement material comprises fiberglass, carbon fibers, graphene, graphene oxide, or any combination thereof.

The Abstract at the end of this disclosure is provided to comply with 37 C.F.R. § 1.72(b) to allow the reader to quickly ascertain the nature of the technical disclosure. It is submitted with the understanding that it will not be used to interpret or limit the scope or meaning of the claims.

Moreover, it is the express intention of the applicant not to invoke 35 U.S.C. § 112, paragraph 6 for any limitations of any of the claims herein, except for those in which the claim expressly uses the word “means” together with an associated function.

What is claimed is:

1. A method of preparing a proton exchange membrane (PEM), comprising:
mixing a precursor of a perfluorosulfonic acid polymer with a second material to form a precursor material in a reduced humidity zone;
extruding the precursor material under reduced humidity to form a filament;
3D printing the PEM with the filament;
converting the precursor of the perfluorosulfonic acid polymer to the perfluorosulfonic acid polymer within the PEM; and
coating the PEM with a conductive material that is at least essentially free of platinum.

2. The method of claim 1, wherein the second material comprises a perfluoroalkoxy alkane (PFA), polybenzimidazole, polyethersulfone, sulfonated polyimide, a water-soluble material, or a combination thereof.

3. The method of claim 2, wherein the water-soluble material comprises polyvinyl alcohol (PVA), poly (ether ether ketone) (PEEK), or a combination thereof.

4. The method of claim 2, wherein mixing the precursor of the perfluorosulfonic acid polymer with the second material comprises mixing the precursor of the perfluorosulfonic acid polymer with the second material and a reinforcement material.

5. The method of claim 4, wherein the reinforcement material comprises fiberglass, polyvinylidene fluoride (PVDF), carbon fibers, graphene, graphene oxide, or any combination thereof.

6. The method of claim 1, wherein the 3D printing comprises using a multi-filament printer.

7. The method of claim 6, wherein the 3D printing comprises 3D printing with an additional filament in an arrangement: in between layers of the filament, in between fibers of the filament to form a layer, interwoven with the filament, or interknit with the filament.

8. The method of claim 7, wherein the additional filament comprises a water or solvent soluble material, a reinforcement fiber, sulfonated poly(ether ether ketone) (sPEEK), polyvinylidene fluoride (PVDF), a perfluorosulfonic acid polymer, or a combination or a reaction product thereof.

9. The method of claim 8, wherein the additional filament comprises the reinforcement fiber, and the reinforcement fiber comprises fiberglass, PVDF, or carbon fibers.

10. The method of claim 1, further comprising at least one of:
heat pressing the PEM;
hot rolling the PEM;
washing the PEM in deionized water; or
drying the PEM.

11. The method of claim 1, wherein the PEM forms a substrate and the coating comprises disposing a layer of graphene over the PEM substrate.

12. The method of claim 11, wherein the PEM is coated on both sides and the graphene is doped with another element.

13. The method of claim 1, wherein the coating comprises spin coating or spray coating.

14. The method of claim 13, wherein the coating comprises spray coating, and the PEM forms a substrate that is spray coated by a 3D printer.

15. A proton exchange membrane prepared by the method of claim 1.

16. A fuel cell comprising:
an anode and a first fluid;
a cathode and a second fluid; and
the proton exchange membrane of claim 13 disposed therebetween to inhibit mixing of the first and second fluids.

17. A method of preparing a proton exchange membrane (PEM), comprising:
mixing pellets of a precursor of a perfluorosulfonic acid polymer, a second material, and a reinforcement material to form a precursor material in a reduced humidity environment;
extruding the precursor material under reduced humidity conditions to form a filament;
chopping the filament into pellets comprising the precursor, the second material, and the reinforcement material;
extruding the pellets comprising the precursor, the second material, and the reinforcement material into a second filament;
3D printing the PEM with the second filament;
converting the precursor of the perfluorosulfonic acid polymer to the perfluorosulfonic acid polymer within the PEM; and
coating the PEM with a layer of graphene.

18. The method of claim 17, wherein the second material comprises a perfluoroalkoxy alkane (PFA), a water-soluble material, or a combination thereof, and the reinforcement material comprises fiberglass, polyvinylidene fluoride (PVDF), carbon fibers, graphene, or a combination thereof.

19. The method of claim 17, wherein the 3D printing comprises 3D printing with an additional filament in an arrangement: in between layers of the second filament, in between fibers of the second filament to form a layer, interwoven with the second filament, or interknit with the second filament.

20. The method of claim 19, wherein the additional filament comprises a water or solvent soluble material, a reinforcement fiber, sulfonated poly(ether ether ketone) (sPEEK), polyvinylidene fluoride (PVDF), a perfluorosulfonic acid polymer, or a combination or reaction product thereof.
